(19) United States
(12) Patent Application Publication
(10) Pub. No.: US 2006/0008696 A1
(43) Pub. Date: Jan. 12, 2006

(54) Nanotubular solid oxide fuel cell

(76) Inventors: Suk-Won Cha, Seoul (KR); Stacey Francine Bent, Stanford, CA (US); Tim Holme, Stanford, CA (US); Xirong Jiang, Stanford, CA (US); Friedrich B. Prinz, Woodside, CA (US); Yuji Saito, Tokyo (JP)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/171,112

(22) Filed: Jun. 29, 2005

Related U.S. Application Data
(60) Provisional application No. 60/584,767, filed on Jun. 30, 2004.

(51) Int. Cl. H01M 8/02; H01M 4/90; H01M 8/10; H01M 4/92; B05D 5/12; H01M 4/88

(52) U.S. Cl. 429/38; 429/40; 429/30; 429/44; 427/115; 502/101

(57) ABSTRACT

A membrane electrode assembly (MEA) having a nano-tubular patterned structure and having solid (instead of porous) electrode layers is provided. Increased mechanical strength is provided by the use of solid electrode layers. The electrode layers are sufficiently thin to permit the flow of reactants to the electrolyte. The nano-tubular pattern includes multiple closed-end tubes and increase the reaction area to volume ratio of the MEA. The nano-tubular pattern also serves to increase mechanical strength, especially in a preferred honey-comb like arrangement of the closed-end tubes. A catalyst is preferably disposed on the anode and cathode surfaces of the MEA, and is preferably in the form of separated catalyst islands in order to increase reaction area. MEAs according to the invention can be fabricated by layer deposition on a patterned template. Atomic layer deposition is a preferred deposition technique.

### CROSS REFERENCE TO RELATED APPLICATIONS

This application claims the benefit of U.S. provisional patent application 60/584,767, entitled “Thin-Film Solid Oxide Fuel Cell”, filed on Jun. 30, 2004, and incorporated by reference in its entirety.

### FIELD OF THE INVENTION

This invention relates to membrane electrode assemblies for fuel cells.

### BACKGROUND

Fuel cells provide electrical power generated by an electrochemical reaction. The reactants are typically a fuel (e.g., hydrogen) and an oxidizer (e.g., atomic or molecular oxygen). The fuel cell reaction takes place in or near an electrolyte, and electrodes (e.g., an anode and a cathode) are connected to the electrolyte in order to collect fuel cell output electrical current. The electrolyte conducts ions, but does not conduct electrons. The following description relates to solid oxide fuel cells, which are fuel cells having a solid oxide electrolyte. A catalyst is usually present at or near at least one of the electrodes, to facilitate the fuel cell reaction. Fuel cells have been under extensive development for many years. Accordingly, various fuel cell configurations have been considered in the art, which often differ from each other in structural and/or geometrical details relating to the electrolyte and electrodes.

For example, a commonly employed fuel cell configuration includes an integrated membrane electrode assembly (MEA). The MEA is a three layer structure with an electrolyte sandwiched between the electrodes. The electrodes are usually porous (e.g., as in U.S. Pat. No. 6,645,656) in order to permit flow of the fuel and oxidant through the electrode layers to the electrolyte. Elaborations on the basic idea of porous electrodes have been investigated. For example, U.S. Pat. No. 6,361,892 considers an electrode having through channels with a selected cross-section, to controllably modify reactant flow.

A significant motivation for the MEA configuration is to increase available reaction area. More specifically, the large interfaces between electrodes and electrolyte in an MEA provide much more reaction area than structures with point or wire electrode contacts. This desirable MEA feature has been further developed in U.S. Pat. No. 6,835,488, where an MEA is patterned in a mesoscopic 3-D pattern to further increase reaction area. Another example of a patterned MEA is considered in U.S. Pat. No. 5,518,829.

Instead of using a patterned MEA, an alternative approach for increasing fuel cell reaction area includes nanotubes (e.g., porous carbon nanotubes) in the MEA. Such approaches are considered in U.S. 2004/0170884 and U.S. 2004/0224217. Nanotubes have also been used as part of a support structure/flow plate in contact with an MEA, as in U.S. Pat. No. 6,589,682. Another approach for increasing reaction area (or power density) is considered in U.S. Pat. No. 6,495,279, where film deposition techniques are employed to fabricate multiple MEAs on top of each other in a stacked manner.

A noteworthy trend in the development of fuel cell technology is scaling the MEA to smaller and smaller dimensions (e.g. by reducing electrode and electrolyte layer thickness). A significant motive for this scaling is reducing internal fuel cell loss (e.g., ohmic ionic loss in the electrolyte). Such scaling can lead to problems not encountered in larger structures. In particular, mechanical fragility is an increasingly significant issue as MEA layer thickness decreases. The porous layers typically employed for anode and cathode electrode layers in an MEA are particularly troublesome, since the presence of pores in these layers significantly reduces their mechanical strength. Furthermore, since the electrolyte layer is preferably thin (to reduce its ohmic loss), it cannot easily be used to provide mechanical support for the electrodes.

Accordingly, it would be an advance in the art to provide a fuel cell MEA having improved mechanical strength and thereby scalable to smaller layer thicknesses than known MEAs. A further advance in the art would be to provide such an MEA having enhanced reaction area and catalytic activity.

### SUMMARY

A membrane electrode assembly (MEA) having a nano-tubular patterned structure and having solid (instead of porous) electrode layers is provided. Increased mechanical strength is provided by the use of solid electrode layers. The electrode layers are sufficiently thin to permit the flow of reactants to the electrolyte. The nano-tubular pattern includes multiple closed-end tubes and increase the reaction area to volume ratio of the MEA. The nano-tubular pattern also serves to increase mechanical strength, especially in a preferred honey-comb like arrangement of the closed-end tubes. A catalyst is preferably disposed on the anode and cathode surfaces of the MEA, and is preferably in the form of separated catalyst islands in order to increase reaction area. MEAs according to the invention can be fabricated by layer deposition on a patterned template. Atomic layer deposition is a preferred deposition technique.

### BRIEF DESCRIPTION OF THE DRAWINGS

FIGS. 1a and 1b show perspective and cross-section views, respectively, of a template suitable for fabricating an embodiment of the invention.

FIGS. 2a-f show a sequence of processing steps suitable for fabricating a preferred embodiment of the invention.

FIGS. 3a-b show exemplary MEA support structures suitable for use with the invention.

FIG. 4 shows a close up cross section view of an MEA according to an alternate embodiment of the invention.

### DETAILED DESCRIPTION

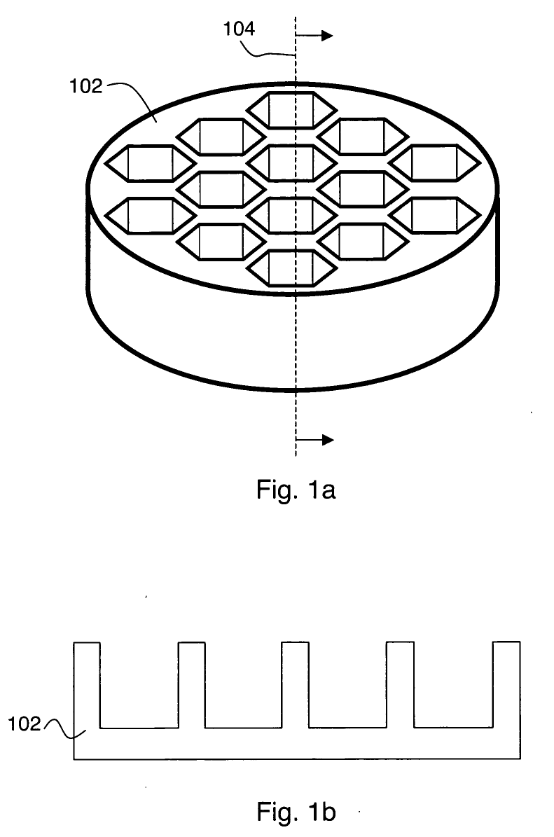

FIGS. 1a and 1b show perspective and cross-section views, respectively, of a template 102 suitable for fabricating a preferred embodiment of the invention. FIG. 1b shows a cross section view of template 102 along line 104 on FIG. 1a. A key feature of templates suitable for fabricating embodiments of the invention is that they include at least two closed-end tubes. As indicated in the following description, MEA fabrication on such a template leads to approximate replication of these closed-end tubes in the MEA. In the example of FIGS. 1a-b, the tubes are arranged on a hexagonal lattice and themselves have a hexagonal cross section. More generally, the tubes can be arranged on a periodic lattice (e.g., a square or rectangular lattice), a quasi-periodic arrangement or an aperiodic arrangement. The tube cross section can be any shape (e.g., square, rectangular, circular, elliptical, etc.). The tubes of the present invention are micron or sub-micron features. More specifically, the depth of the tubes is preferably between about 20 nm and about 10 μm, and the lateral extent of the tubes is preferably less than 10 μm and is more preferably between about 20 nm to about 2 μm.

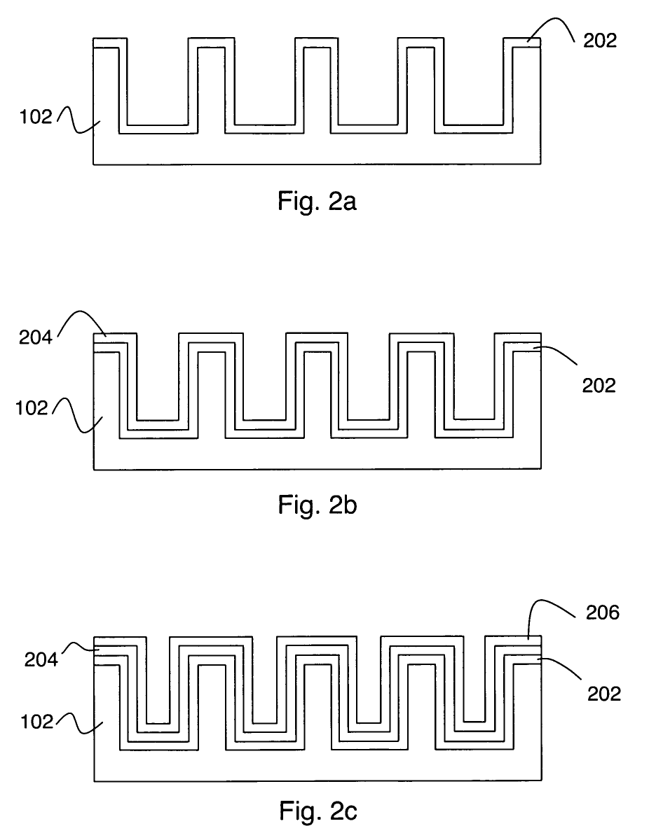

Template 102 can be made from any material compatible with the MEA fabrication steps of FIGS. 2a-e. Suitable materials include silicon, silicon oxide, metal oxides (such as anodized alumina), and polymers. The closed-end tubes can be formed in template 102 by known microfabrication and/or nanofabrication techniques (e.g., lithography, anodization and/or self-assembly techniques).

FIGS. 2a-f show a sequence of processing steps suitable for fabricating a preferred embodiment of the invention. In summary, a first electrode layer, an electrolyte layer, and a second electrode layer are deposited in succession on a suitably patterned template (e.g., 102 on FIG. 1a). These three layers together form an MEA which has the desired features (i.e., closed-end tubes). The first electrode layer can be the anode and the second electrode layer can be the cathode. Alternatively, the first electrode layer can be the cathode and the second electrode layer can be the anode. Optionally, a catalyst is disposed on the first and/or second electrode layers.

FIG. 2a shows deposition of a first electrode layer 202 on template 102. In this example, first electrode layer 202 is a fuel-permeable, non-porous anode 202. The thickness of anode 202 is preferably in a range from about 2 nm to about 500 nm. Since anode 202 is not porous (i.e., does not include any voids extending across the anode thickness), diffusion of the fuel (in atomic, molecular and/or ionic form) through the solid anode is required for the fuel to reach the electrolyte. Such diffusion proceeds more efficiently as the anode thickness decreases. However, anode mechanical strength decreases as anode thickness decreases. Therefore, specific MEA designs according to the invention will require these competing factors to be appropriately balanced. Such balancing is within the skill of an art worker.

Suitable materials for anode 202 include: platinum, nickel, palladium, silver, doped perovskites (e.g., manganites, cobaltites and ferrites), and mixtures thereof. Suitable dopants for these perovskites include lanthanum, strontium, barium, cobalt and mixtures thereof. In more general terms, the anode is preferably a mixed ionic conductor having high conductivity for both ions and electrons. Suitable techniques for depositing anode 202 include sputtering, chemical vapor deposition, pulsed laser deposition, molecular beam epitaxy, evaporation and atomic layer deposition. Atomic layer deposition (ALD) is a preferred deposition technique because it can provide precise layer thickness control even when growth is performed on a patterned template having high aspect ratio features (i.e., the tubes).

FIG. 2b shows deposition of a solid oxide electrolyte layer 204 on anode 202. Suitable materials for electrolyte 204 include metal oxides having fluorite structure (e.g., stabilized zirconia, doped ceria, and doped bismuth oxide) and perovskites. Fluorite structure oxides can be doped with yttrium, scandium, gadolinium, ytterbium and/or samarium. The above electrolyte perovskites can have an ABO₃ composition where A is lanthanum, calcium, strontium, samarium, praseodymium, or neodymium and B is aluminum, gallium, titanium or zirconium. Suitable dopants for electrolyte perovskites include lanthanum, strontium, barium, cobalt, magnesium, aluminum, calcium and mixtures thereof. The thickness of electrolyte 204 is preferably in a range from about 5 nm to about 500 nm. The above-mentioned techniques for depositing anode 202 are also applicable to depositing electrolyte 204. ALD is a preferred technique for electrolyte deposition.

FIG. 2c shows deposition of a second electrode layer 206 on electrolyte 204. In this example, second electrode layer 206 is an oxidant-permeable, non-porous cathode 206. The thickness of cathode 206 is preferably in a range from about 2 nm to about 500 nm. Since cathode 206 is not porous (i.e., does not include any voids extending across the cathode thickness), diffusion of the oxidant (in atomic, molecular and/or ionic form) through the solid cathode is required for the oxidant to reach the electrolyte. Such diffusion proceeds more efficiently as the cathode thickness decreases. However, cathode mechanical strength decreases as cathode thickness decreases. Therefore, specific MEA designs according to the invention will require these competing factors to be appropriately balanced. Such balancing is within the skill of an art worker.

Suitable materials for cathode 206 include: platinum, nickel, palladium, silver, doped perovskites (e.g., manganites, cobaltites and ferrites), and mixtures thereof. Suitable dopants for these perovskites include lanthanum, strontium, barium, cobalt and mixtures thereof. In more general terms, the cathode is preferably a mixed ionic conductor. The above-mentioned techniques for depositing anode 202 are also applicable to depositing cathode 206. ALD is a preferred technique for cathode deposition. The exemplary fabrication sequence of FIGS. 2a-f shows deposition of cathode on top of electrolyte on top of anode. Alternatively, deposition of anode on top of electrolyte on top of cathode can be used to fabricate embodiments of the invention.

FIG. 2d shows optional deposition of a cathode catalyst 208 on cathode 206. Preferably catalyst 208 includes multiple sub-micron catalyst islands separated from each other (as shown), in order to increase the effective reaction area of the catalyst. It is preferable for some of these catalyst islands to be disposed inside the closed-end tubes, in order to exploit the increased surface area provided by the tubes. Suitable catalyst materials include platinum, nickel, palladium, silver, and mixtures or alloys thereof. Preferably, catalyst 208 is deposited via ALD in a growth parameter regime that inherently provides islanded growth (e.g., as considered in U.S. 2003/0194598). In this manner, catalyst islands can be deposited on the patterned cathode without requiring a separate catalyst patterning step. Catalyst 208 preferably facilitates the incorporation of oxidant into cathode 206 in a form that can diffuse through the cathode.

FIG. 2e shows removal of template 102 from the membrane electrode assembly including anode 202, electrolyte 204 and cathode 206. Such removal can be performed by any process (e.g., etching) that selectively removes template 102 while not degrading the MEA.

FIG. 2f shows optional deposition of an anode catalyst 210 on anode 202. The description of cathode catalyst 208 in connection with FIG. 2d is also applicable to anode catalyst 210. Catalyst 210 preferably facilitates the incorporation of fuel into anode 202 in a form that can diffuse through the anode. The completed MEA structure 250 shown in FIG. 2f has several important structural features. In particular, MEA 250 includes closed-end tubes which are replicas (or near replicas) of the closed end tubes of template 102. Although MEA 250 is thereby patterned, its thickness is substantially uniform. More specifically, the separation between an anode surface 230 and a cathode surface 220 is substantially uniform within the MEA. This “folding” of an otherwise planar MEA advantageously increases the area to volume ratio of the MEA.

The mechanical strength of MEA 250 is advantageously increased by two important structural features. First, the anode and cathode layers are solid layers, in contrast to conventional porous electrode layers. Such solid layers provide increased mechanical strength. Second, the tubular pattern of MEA 250 can act to increase mechanical strength, especially in the preferred configuration shown on FIG. 1a, where the geometry is similar to that of a honeycomb. Honeycomb type geometries tend to be effective for increasing mechanical strength. By increasing mechanical strength in this manner, the present invention facilitates further decrease of electrode and electrolyte layer thickness, which in turn can advantageously reduce fuel cell loss.

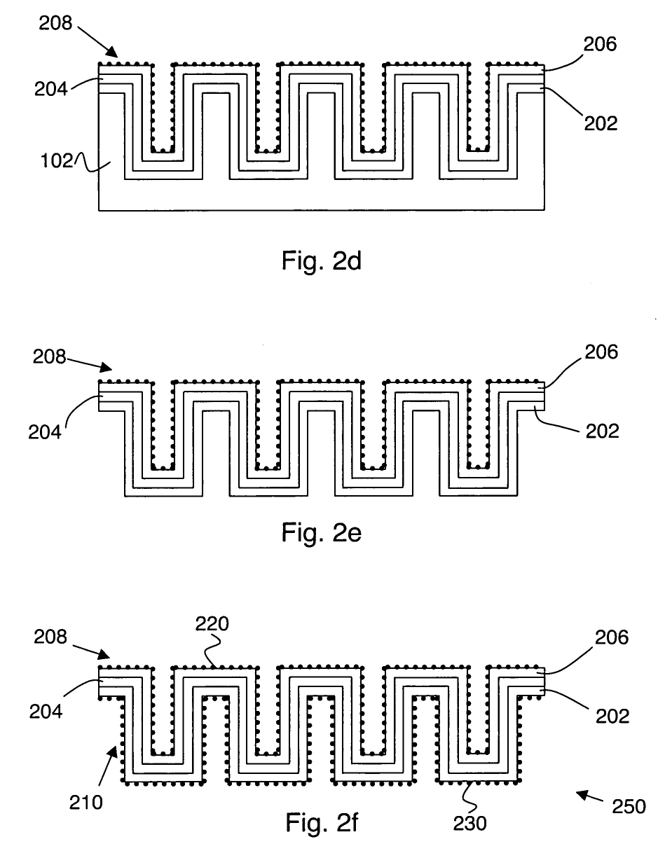

Membrane electrode assemblies according to the invention are preferably supported by mechanical support structures. Suitable support structures are known in the fuel cell art. FIGS. 3a-b show two exemplary MEA support structures suitable for use with the invention. FIG. 3a shows an MEA 250 of the present invention on a support structure 302. Support structure 302 is preferably porous and electrically conductive, in order to facilitate reactant flow to MEA 250 and to provide electrical contact to MEA 250. An alternative arrangement is shown on FIG. 3b, where a flow plate 304 includes channels for reactant flow to MEA 250. Flow plate 304 need not be porous, since the channels provide a reactant flow path. However, flow plate 304 is preferably electrically conductive in order to provide electrical contact to MEA 250. Although FIGS. 3a-b show support on only one side of the MEA, it is preferred for both sides of the MEA to be in contact with suitable support structures.

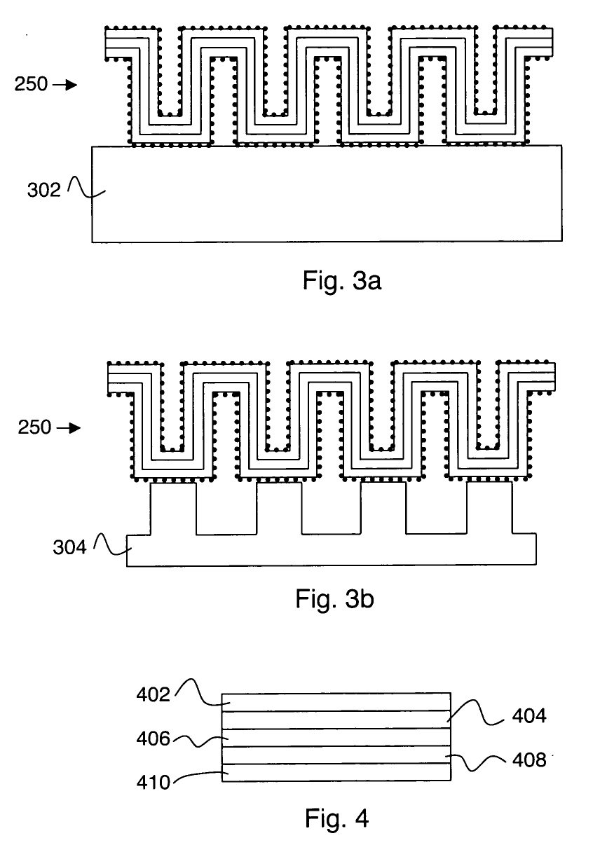

The preceding description has been by way of example as opposed to limitation. Many variations of the preceding examples also fall within the scope of the present invention. Foe example, the MEA anode and cathode regions can include both porous and non-porous layers. FIG. 4 shows a close up (i.e., on a smaller scale than the tubular patterning) cross section view of an MEA according to the invention and having such a structure. In this example, an electrolyte 406 is sandwiched between non-porous anode and cathode layers 404 and 408 respectively. A porous anode layer 402 is adjacent to non-porous anode layer 404. A porous cathode layer 410 is adjacent to non-porous cathode layer 408. Use of both porous and non-porous electrode layers provides additional design parameters for optimizing the combination of mechanical strength and fuel cell performance. Porous electrode layers 402 and 410 can be made of the same materials described above as suitable for non-porous electrode layers.

Another variation is to alter the geometry so that the closed-end tubes extend inward from both the anode surface and the cathode surface, as opposed to extending inward from only one of the surfaces (as shown on FIG. 1a). A further variation of the invention is to include electrolyte materials in the anode or cathode composition. More specifically, materials described above in connection with electrolyte 204 can be included in anode 202 and/or in cathode 206. The addition of electrolyte material to the electrodes can increase the ionic conductivity of the anode and/or cathode, as well as decrease the interfacial resistance at the electrolyte-anode interface and/or the electrolyte-cathode interface.

1. A membrane electrode assembly for a solid oxide fuel cell, the assembly comprising:
a fuel permeable, non-porous, solid, thin film anode;
an oxidant permeable, non-porous, solid, thin film cathode;
a thin film solid oxide electrolyte;
wherein the electrolyte is sandwiched between the anode and the cathode to form a layered composite;
wherein the layered composite has an anode surface facing away from an anode-electrolyte interface and has a cathode surface facing away from a cathode-electrolyte interface and wherein a distance between the anode surface and the cathode surface is substantially uniform within the membrane electrode assembly;
wherein the layered composite is disposed in a three-dimensional pattern having features, and wherein the features include a plurality of discrete closed-end tubes extending inward from at least one of the anode surface and the cathode surface.

2. The membrane electrode assembly of claim 1, wherein said anode includes a material selected from the group consisting of: platinum, nickel, palladium, silver, doped perovskites, and mixtures thereof.

3. The membrane electrode assembly of claim 1, wherein said anode has a thickness from about 2 nm to about 500 nm.

4. The membrane electrode assembly of claim 1, wherein said cathode includes a material selected from the group consisting of: platinum, nickel, palladium, silver, doped perovskites, and mixtures thereof.

5. The membrane electrode assembly of claim 1, wherein said cathode has a thickness from about 2 nm to about 500 nm.

6. The membrane electrode assembly of claim 1, wherein said electrolyte includes a material selected from the group consisting of: fluorites, doped ceria, doped bismuth oxide and perovskites.

7. The membrane electrode assembly of claim 6, wherein said fluorites are doped with yttrium, scandium, gadolinium, ytterbium or samarium.

8. The membrane electrode assembly of claim 6, wherein said perovskites have an ABO₃ composition; wherein A is lanthanum, calcium, strontium, samarium, praseodymium, or neodymium; and wherein B is aluminum, gallium, titanium or zirconium.

9. The membrane electrode assembly of claim 8, wherein said perovskites are doped with a material selected from the group consisting of lanthanum, strontium, barium, cobalt, magnesium, aluminum, calcium and mixtures thereof.

10. The membrane electrode assembly of claim 1, wherein said electrolyte has a thickness from about 5 nm to about 500 nm.

11. The membrane electrode assembly of claim 1, wherein said anode comprises a mixed ionic conductor and wherein said cathode comprises a mixed ionic conductor.

12. The membrane electrode assembly of claim 1, wherein said plurality of discrete closed-end tubes comprises:
a first plurality of discrete closed-end tubes extending inward from said anode surface; and
a second plurality of discrete closed-end tubes extending inward from said cathode surface.

13. The membrane electrode assembly of claim 1, wherein said tubes have a depth from about 20 nm to about 10 μm.

14. The membrane electrode assembly of claim 1, wherein said tubes have a lateral extent from about 20 nm to about 2 μm.

15. The membrane electrode assembly of claim 1, wherein said tubes are arranged on a periodic lattice.

16. The membrane electrode assembly of claim 15, wherein said periodic lattice is a hexagonal lattice, a square lattice or a rectangular lattice.

17. The membrane electrode assembly of claim 1, further comprising a catalyst disposed on said anode surface and disposed on said cathode surface.

18. The membrane electrode assembly of claim 17, wherein said catalyst comprises a plurality of sub-micron catalyst islands separated from each other.

19. The membrane electrode assembly of claim 18, wherein some of said catalyst islands are disposed inside said tubes.

20. The membrane electrode assembly of claim 17, wherein said catalyst comprises a material selected from the group consisting of platinum, nickel, palladium, silver, and mixtures or alloys thereof.

21. The membrane electrode assembly of claim 1, further comprising a porous anode layer adjacent to said anode surface.

22. The membrane electrode assembly of claim 1, further comprising a porous cathode layer adjacent to said cathode surface.

23. A fuel cell comprising:
a membrane electrode assembly according to claim 1; and
a porous, electrically conductive mechanical support structure disposed adjacent to the membrane electrode assembly.

24. A method of fabricating a membrane electrode assembly for a fuel cell, the method comprising:
first depositing a non-porous, solid, thin film first electrode layer;
electrolyte depositing a thin film solid oxide electrolyte layer on the first electrode layer;
second depositing a non-porous, solid, thin film second electrode layer on the electrolyte later;
wherein one of the first and second electrode layers is an anode having an anode surface facing away from an anode-electrolyte interface and the other of the first and second electrode layers is a cathode having a cathode surface facing away from a cathode-electrolyte interface;
wherein a distance between the anode surface and the cathode surface is substantially uniform within the membrane electrode assembly;
wherein the anode is fuel permeable and the cathode is oxidant permeable;
wherein the first electrode layer is disposed in a three-dimensional pattern having features, and wherein the features include a plurality of discrete closed-end tubes extending inward from the anode surface or the cathode surface.

25. The method of claim 24, wherein said first depositing, said electrolyte depositing and said second depositing each comprise a deposition method selected from the group consisting of: sputtering, chemical vapor deposition, pulsed laser deposition, molecular beam epitaxy, evaporation and atomic layer deposition.

26. The method of claim 24, wherein said first depositing comprises depositing said first electrode layer on a lithographically processed template, whereby said pattern is lithographically defined.

27. The method of claim 24, further comprising catalyst depositing a catalyst on at least one of said anode surface and said cathode surface.

28. The method of claim 27, wherein said catalyst depositing comprises atomic layer deposition performed in a growth regime providing islanding growth, whereby said catalyst is disposed as separated islands.
